(19) United States
(12) Patent Application Publication
(10) Pub. No.: US 2010/0133084 A1
(43) Pub. Date: Jun. 3, 2010

(54) PROCESS FOR MAKING STEEL INDUSTRY FUEL

(75) Inventors: Kenneth D. Burnside, Fort Myers, FL (US); Daniel C. Deer, III, Fort Meyers, FL (US)

Correspondence Address: MARSHALL, GERSTEIN & BORUN LLP, 233 SOUTH WACKER DRIVE, 6300 WILLIS TOWER, CHICAGO, IL, 60606-6357, US

(73) Assignee: AKJ INDUSTRIES, INC., Fort Meyers, FL (US)

(21) Appl. No.: 12/616,864

(22) Filed: Nov. 12, 2009

Related U.S. Application Data
(60) Provisional application No. 61/113,693, filed on Nov. 12, 2008.

(51) Int. Cl. C10B 57/00; C09K 3/00

(52) U.S. Cl. 201/2.5; 252/182.12

(57) ABSTRACT

A method of reducing costs in the steel industry by making a Steel Industry Fuel comprising solublizing a portion of a coking waste product with a green solvent, to form a mixture and adding the mixture to coal wherein a prefuel mixture of the green solvent and the coking waste product has a lower viscosity than the coking waste product prior to the addition of the green solvent and wherein the green solvent is a combustible fuel derived from a renewable source, and adding the prefuel mixture of the green solvent and the coking waste product to a coal.

### CROSS-REFERENCE TO RELATED APPLICATIONS

This application claims priority from U.S. Provisional Patent Application No. 61/113,693 filed Nov. 12, 2008. The content of which is incorporated herein in its entirety.

### FIELD OF THE DISCLOSURE

The present disclosure is directed to a fuel used in the manufacture of blast furnace coke, particularly a fuel made from recycled waste products from the coking process. More particularly, the present disclosure is directed to reducing the costs of operating a coking oven. The disclosure is additionally directed to a Steel Industry Fuel that is made with recycled coal tar sludge or coal tar decanter sludge, mixed with one or more green solvents and applied to coal that is fed to a coking oven. The coal, recycled waste product from the coking process, and green solvent are combined to form Steel Industry Fuel. In a preferred embodiment, the green solvent mixed with the coal tar sludge, and applied to coal, is a product from a biodiesel manufacturing process, preferably a “waste biodiesel,” defined herein as a biodiesel product that does not meet the biodiesel specification (ASTM D6751-09) for biodiesel (B100).

### BACKGROUND

Coal is thermally pyrolized or distilled by heating without contact with air at a temperature of about 950 to 1800° F. in a coke oven to produce coke and a variety of liquid and gaseous by-products. The liquid and gaseous by-products of coke include, as liquids, water, coal tar and crude light oil and include as gaseous products hydrogen, methane, ethylene, carbon monoxide, carbon dioxide, hydrogen sulfide, ammonia, and nitrogen.

Until about the middle of the nineteenth century, the coal tar by-product of coke was regarded as a waste material but, increasingly, uses have been found for coal tar products. For example, some of the coal tars meet specifications required for roofing and road tars. Other coal tars have been reduced in viscosity by dilution with solvents and the diluted coal tars used as a fuel in open-hearth furnaces.

While others have found uses for most of the coal tar by-products from the coking oven, the coal tar sludges remain as waste products, such as coal tar tank sludge, and particularly a fraction of coal tar known as coal tar “decanter sludge”. Generally, coal tar from the coking oven is first received in a coal tar decanter vessel which also receives some fine solid particles of coal and coke from the coking oven. These solid particles settle to the bottom of the coal tar decanter vessel where they agglomerate by binding with coal tar together with other solid waste materials, such as ash, into cementaciously bound solid waste products known as “tar decanter sludge”. The useful liquid coal tar is decanted from the coal tar decanter vessel into a coal tar holding tank maintained heated for sufficiently low viscosity for pumping to suitable transport vessels. The coal tar holding tank also produces a sludge at the bottom of the vessel called a “tank sludge”, comprising solid deposits of tar, sludge, ash and quinoline—predominantly solvent-soluble hydrocarbons.

The tar decanter sludges, on the other hand, include a substantial percentage of non-dissolvable solids, such as coal and coke, which, together with the viscous coal tar received in the coal tar decanter vessel, results in a sludge containing approximately 10 to 50% by weight solid particles of coal and coke with the remainder being very viscous, sticky coal tar and other hydrocarbon materials tending to bind adjacent coal and coke particles together into cementacious agglomerates.

The combination of coal tar and coal and coke solids (tar decanter sludge) remains today as a hazardous waste product that has been used as a fuel in the coking oven, as described in this assignee's U.S. Pat. Nos. 4,579,563; 4,758,246; and 4,778,115.

Similarly, biodiesel fuel manufacture produces significant toxic waste products that inhibit the industry by preventing the conversion of biomaterial to fuel from being profitable. The manufacture of biodiesel through transesterification results in approximately one pound of biodiesel waste product for every ten pounds of biodiesel produced. As the biodiesel industry has exploded, so has the supply of crude glycerin, a major component of biodiesel waste, and it is expected to reach in excess of 350,000 tons/year in the U.S. and 600,000 tons/year in Europe. Crude glycerin contains artifacts from the biodiesel process like catalysts, alcohol, and soap and is therefore very costly to refine into higher-grade, pure glycerol. As a consequence, crude glycerin market prices have collapsed and the biodiesel industry is struggling with viable options for the glut of glycerin on hand.

In accordance with the methods and compositions described herein, a single method has been found capable of using both coal tar sludge and biodiesel or waste biodiesel products by combining them with coal to form a single useful fuel; the product therefrom being a commercially viable Steel Industry Fuel.

### SUMMARY OF THE INVENTION

In brief, the present invention is directed to a method for making and using a Steel Industry Fuel, and the resulting Steel Industry Fuel composition comprising coal, and at least one waste product from the manufacture of coke together with a green solvent—a non-petroleum-derived solvent that is preferably derived from vegetable oils and/or animal fats. In accordance with the preferred compositions and methods described herein, the Steel Industry Fuel is made with a biodiesel or glycol bottoms solvent, admixed with a coking plant sludge thereby reducing, in part, the environmental impact of the overall coking process. Additionally, the recycling of the waste product from the manufacture of coke further reduces the volume of hazardous waste from the manufacture of steel.

An important aspect of the present invention is the recycling of one or more of coking waste products, for example coal tar, coal tar sludge, and/or coal tar decanter sludge. In accordance with one embodiment of the compositions and methods described herein, a coking waste product received from the coke oven, including approximately 10 to 50% by weight coal and coke solids, is mechanically and chemically processed into a pumpable mixture and this mixture is added to coal to form Steel Industry Fuel for addition to the coking oven.

In accordance with one embodiment, coal tar sludge, and particularly coal tar decanter sludge, is processed to a relatively homogeneous mixture of solids dispersed in liquid. In accordance with another embodiment, coal tar decanter sludge received from the coke oven, including approximately 10 to 50% by weight coal and coke solids, is fed into a sludge mixing vessel where it is deposited onto a liquid-permeable support member or screen having a predetermined maximum screen size, e.g., about 0.5 to about 1 inch. A green solvent added to the sludge mixing vessel is heated to a temperature sufficient to partially solubilize and reduce the viscosity of the coal tar portion of the coal tar decanter sludge to provide a pumpable dispersion of solids dispersed in a diluted coal tar mixture. Agglomerates of coal and coke solids held together with coal tar fall through the screen when sufficient coal tar has solubilized and the solid agglomerates then are reduced in size to fall through the screen for recirculation to the sludge mixing vessel.

In accordance with an important feature of one embodiment described herein, the diluted coal tar mixture is pumped to recirculate it to the sludge mixing vessel after impacting and shearing the solid agglomerates to reduce the solids particle size. To achieve the full advantage of the compositions and methods described herein, agglomerates of the diluted coal tar mixture are impacted with a rotating impacting blade or disintegrator to physically break the solid deposits of coal and coke cementaciously held together with coal tar thereby reducing the particle size of the solid agglomerates and to increase the contact area of the solid agglomerates with the green solvent.

In accordance with another important feature of the preferred embodiment of the compositions and methods described herein, the solid agglomerates in the diluted coal tar mixture are conveyed through an array of inlet openings of a shear plate and the solid agglomerates in the diluted mixture are then sheared by a rotating impeller blade for further reduction of the particle size of the coal and coke solids tar-bound agglomerates. To achieve the full advantage of the present invention, the agglomerates are impacted prior to shearing to achieve sufficient particle size reduction for passage of the remaining agglomerates through the shear plate openings.

Accordingly, an object of the compositions and methods described herein is to provide a new and improved method for physically and chemically processing coking waste products and adding them to a coking oven, as coking fuel or Steel Industry Fuel.

Still another object of the compositions and methods described herein is to provide a new and improved method and apparatus for fluidizing coal tar sludge agglomerates comprising solid particles of coal and/or coke cementaciously held together with coal tar by contacting the agglomerates of coal, coke and coal tar with a suitable green solvent to partially separate the agglomerates, and physically impacting and shearing the agglomerates to further reduce the agglomerates to a pumpable mixture of solids dispersed in a green liquid solvent.

Another object of the compositions and methods described herein is to provide a new and improved method and apparatus for fluidizing coal tar decanter sludge, mixed with other waste products in a waste storage lagoon, to provide a pumpable mixture of solids and liquid and adding the product to a coking fuel to be used in the manufacture of blast furnace coke.

The above and other objects and advantages of the invention will become apparent from the following detailed description of the preferred embodiments described with reference to the drawings.

### BRIEF DESCRIPTION OF THE DRAWINGS

FIG. 1 is a partially elevated cross-sectional view of an apparatus applicable in the present invention;

FIG. 2 is a partially broken-away, cross-sectional view showing a pump portion of the apparatus taken through the line 2-2 of FIG. 1;

FIG. 3 is a partially broken-away, cross-sectional view showing a pump portion of the apparatus taken through the line 3-3 of FIG. 1; and

FIG. 4 is a partially elevated cross-sectional view of another apparatus applicable in the present invention, similar to FIG. 1, including an attrition mill.

### DETAILED DESCRIPTION

Herein, ranges may be expressed as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

An important aspect of the method and compositions described herein is the reduction of fuel and disposal costs in the steel industry. Herein is disclosed a method for reducing these fuel and disposal costs comprising processing coal tar sludge with about 1 to about 40 wt. % of a liquid fuel to make a liquefied sludge, applying this liquefied sludge to coal to make a Steel Industry Fuel, calculating a barrel-of-oil equivalency credit, and adjusting the composition of the Steel Industry Fuel to reduce the cost of liquid fuel and increase the British thermal units (BTUs) per ton obtained from the Steel Industry Fuel upon combustion.

Preferably, the liquid fuel cost per ton is less than a coal tar sludge waste disposal cost per ton. The barrel-of-oil equivalency credit is a per rata credit based on BTUs per ton available from the Steel Industry Fuel. The available BTUs are dependent on the Steel Industry Fuel composition, where variation in the amounts of liquid fuel, coal tar sludge, and coal affects the ultimate BTUs available from any specific composition. Often the facility producing the Steel Industry Fuel is not the coking operator. In such arrangements, the coal tar sludge is sold or given to the Steel Industry Fuel manufacturer who in turn applies the methods described herein and sells the Steel Industry Fuel or the liquefied coal tar sludge to the coking operator. Preferably, Steel Industry Fuel is sold to and purchased by a coking operator and added to a coking oven for the manufacture of coke. Where the payment for the Steel Industry Fuel is measured by a fixed dollar amount or a fixed dollar amount per ton of Steel Industry Fuel, without reference to the profit of loss of either the buyer or the seller.

The liquid fuel can be selected from but not limited to, for example, No. 1 fuel oil, No. 2 fuel oil, No. 3 fuel oil, No. 4 fuel oil, No. 5 fuel oil, No. 6 fuel oil, biodiesel, biodiesel waste product, glycerin, waste oil, and mixtures thereof. As will become clear from the disclosure below, the term liquid fuel refers to the liquidity of the fuel at an elevated temperature where the liquid fuel is used to liquefy coking waste products, preferably coal tar sludge, and is then applied to coal. The liquid fuel may in fact be solidified at or near 20° C. Importantly, the liquid fuel should have a cost to BTU rating sufficient to decrease the total cost of operating a coking oven. Typically, the purchase of industrial fuels is contracted for based on commodity futures pricing and these pricing fluxuations affect the cost to BTU rating of any specific liquid fuel. Thereby the pricing fluxuations affect the total cost of operating a coking oven. Therefore it is an important aspect of the present disclosure to offset an increase in the price of the liquid fuel against the available BTUs, alternatively offset a decrease in BTUs against the contracted for price of the liquid fuel.

As is described in further detail below, the processing of coal tar sludge involves heating the liquid fuel to a temperature in a range of 50 to 120° C.; adding the liquid fuel to a coal tar sludge, wherein the coal tar sludge is supported on a screen above a container, and wherein a portion of the liquid fuel dissolves a portion of the coal tar sludge such that a heterogeneous mixture of the liquid fuel, the coal tar sludge, and agglomerated particles passes through the screen into the container; reducing the agglomerated particles to smaller particles; pumping a portion of the heterogeneous mixture to contact the coal tar sludge supported on the screen; and recirculating a portion of the heterogeneous mixture that passes through the screen for contact with a remaining portion of the coal tar sludge supported on the screen, until the coal tar sludge and liquid fuel form a recirculated heterogeneous mixture, wherein the recirculated heterogeneous mixture comprises the liquid fuel, and the coal tar sludge, including particles of coal and coke.

A goal of the present disclosure is to increase the BTUs per ton obtained from the Steel Industry Fuel upon combustion thereby decreasing the overall costs of operating a coking oven. One method for obtaining this goal is by adjusting the Steel Industry Fuel composition to increase the BTUs per ton obtained from the Steel Industry Fuel upon combustion and to minimize a liquid fuel cost per ton.

One aspect of reducing the costs of operating a coking oven is through the reduction of disposal costs of coking waste products and through the use of inexpensive and readily available green solvents. In one example the compositions and methods described herein relate to a partially-recycled coking fuel, Steel Industry Fuel, comprising a green solvent, and a coking waste product added to coal to form the Steel Industry Fuel. The Steel Industry Fuel is then burned in the coking oven, alone, or together with a traditional coking fuel. The Steel Industry Fuel compositions described herein, comprising the green solvent and the coking waste product applied to coal, reduce the overall environmental impact of the steel industry and reduce both the costs associated with the manufacture of steel and, in the preferred embodiment, with the manufacture of biofuels.

A coking waste product is a material recovered from the coking process. Some coking waste products can be purified and sold as commercial products but coal tar sludge, and in particular coal tar decanter sludge, are not commercially viable products from the coking process. Herein, a coking waste product is a combustible waste product from the coking process and preferably a waste product that is a hazardous material and has expensive disposal costs. Importantly, the present invention provides a substantial savings to the steel industry by reducing or eliminating the disposal of coking waste product from coking ovens.

The preferred green solvent for admixture with the coal tar sludge to from Steel Industry Fuel is a biofuel. As used herein, a biofuel is a biologically derived fuel; a chemical or chemical composition made from a renewable source, preferably from vegetable oils, animal fats, and/or recycled greases. Examples of renewable sources include biomass, animal waste, animal byproducts, and by products from the manufacture of diethylene glycol, e.g., glycol bottoms. Specific renewable sources include corn, soy, canola, sunflower, rapeseed, cottonseed, cornstalks, sugar beets, sugar cane, switchgrasses, vegetable oil, vegetable fats, animal oil, edible tallow, inedible tallow, lard, choice white grease, yellow grease, poultry fats, fish oils, animal fats, used cooking oils and restaurant frying oils. An important aspect of the preferred green solvents described herein is that the green solvents are not required to be pure liquid biofuels and can be the waste products from the production of other biofuels. Biofuels produced from a renewable source can be, for example, biodiesel, ethanol, and bagasse. Often, biofuels are esters, particularly methyl esters, of long chain fatty acids that have between about 12 and 22 carbon atoms. Preferred green solvents for admixture with coal to sludge to form Steel Industry Fuel are the impure or “waste” products from the manufacture of these biofuels.

Particularly preferred green solvents include biodiesel fuel; off spec biodiesel; and wasted biodiesel the waste product from the manufacture of biodiesel, called herein a waste biodiesel product. Biodiesel fuel includes methyl soyate, rapeseed methyl ester, methyl tallowate, and methyl esters from lipid sources; for example those chemical products with the CAS numbers 67784-80-9, 73891-99-3, and 61788-71-2. As general features a biodiesel fuel has a atmospheric pressure boiling point greater than 200° C., often between 330 and 360° C., is appreciably insoluble in water, and has a specific gravity less than 1. As described herein, a waste biodiesel product is a product of any biodiesel manufacturing process that does not meet the exact specification for biodiesel (B100)-ASTM D6751-09:

Biodiesel is defined as the mono alkyl esters of long chain fatty acids derived from vegetable
oils or animal fats, for use in compression-ignition (diesel) engines. This specification
is for pure (100%) biodiesel prior to use or blending with diesel fuel.#

| Property | ASTM Method | Limits | | Units |
|---|---|---|---|---|
| Calcium & Magnesium, combined | EN 14538 | 5 | maximum | ppm (ug/g) |
| Flash Point (closed cup) | D93 | 93 | maximum | degrees C. |
| Alcohol Control (One of the | | | | |
| following must be met) | | | | |
| 1. Methanol Content | EN 14110 | 0.2 | maximum | % volume |
| 2. Flash Point | D93 | 130 | minimum | Degrees C. |
| Water & Sediment | D 2709 | 0.05 | maximum | % vol. |
| Kinematic Viscosity. 40 C. | D 445 | 1.9-6.0 | | mm²/sec. |
| Sulfated Ash | D 874 | 0.02 | maximum | % mass |
| Sulfur | | | | |
| S 15 Grade | D 5453 | 0.0015 | max. (15) | % mass (ppm) |
| S 500 Grade | D 5453 | 0.05 | max. (500) | % mass (ppm) |
| Cooper Strip Corrosion | D 130 | No. 3 | maximum | |
| Cetane | D 613 | 47 | minimum | |
| Cloud Point | D 2500 | report | | degrees C. |
| Carbon Residue 100% sample | D 4530* | 0.05 | maximum | % mass |
| Acid Number | D 664 | 0.50 | maximum | mg KOH/g |
| Free Glycerin | D 6584 | 0.020 | maximum | % mass |
| Total Glycerin | D 6584 | 0.240 | maximum | % mass |
| Phosphorus Content | D 4951 | 0.001 | maximum | % mass |
| Distillation, T90 AET | D 1160 | 380 | maximum | degrees C. |
| Sodium/Potassium, combined | EN 14538 | 5 | maximum | ppm |
| Oxidation Stability | EN 14112 | 3 | minimum | hours |
| Cold Soak Filtration | Annex to D6751 | 360 | maximum | seconds |
| For Use in temperatures | Annex to D6751 | 200 | maximum | seconds |
| below −12 C. | | | | |

BOLD = BQ-9000 Critical Specification Testing Once Production Process Under Control
*The carbon residue shall be run on the 100% sample.
#A considerable amount of experience exists in the US with a 20% blend of biodiesel with 80% diesel fuel (820).
Although biodiesel (B100) can be used, blends of over 20% biodiesel with diesel fuel should be evaluated on a case-by-case basis until further experience is available.

One important aspect of the green solvent, specifically the waste biodiesel products described herein, is that it is a combustible fuel. Specifically, the green solvent must be a combustible fuel and preferably should have a heat content of at least about 10 KJ/g.

Another important aspect of the green solvent is that it is a liquid in the range of about 50 to about 120° C. Specifically, the green solvent is not required to be a liquid over the entire range of 50 to 120° C., for example the green solvent can melt at 100° C. and exist as a liquid from 100 to 120° C. Additional applicable examples are those green solvents that are liquid over the range of 50-60° C., 60-70° C., 70-80° C., 80-90° C., 90-100° C., 100-110° C., and/or 110-120° C. The applicable green solvents are not required to be homogeneous liquids over the disclosed temperature ranges. The green solvents can exist in any pumpable liquid form including a homogeneous liquid, a heterogeneous liquid-liquid, a heterogeneous liquid-solid, emulsion, suspension, or other mixed phase form.

The green solvents useful herein can be a biodiesel fuel, or can be the waste product from the production of biodiesel (waste biodiesel product), and in particular the crude (unpurified) glycerin which is a major component of some waste biodiesel products. Crude glycerin has a glycerin concentration of about 90 to about 99% by weight, with the remainder being other by-products of the biodiesel manufacturing process.

Another important aspect of the invention is combining the coking waste product and the green solvent, and contacting coal with the combination to form a Steel Industry Fuel. One embodiment of a “Steel Industry Fuel” is the combination product of the coking waste product and the green solvent mixed with, absorbed, or adsorbed onto coal. To be applicable here, the viscosity of the liquid components of the Steel Industry Fuel is required to be lower than the viscosity of the coking waste product. Specifically, the viscosity of the liquid components of the Steel Industry Fuel is required to be lower than the viscosity of the coking waste product over the temperature range of 50 to 120° C., and more specifically over the range at which the green solvent is a liquid. As one illustrative example, the viscosity of a mixture of a biodiesel product and coal tar decanter sludge over the temperature range of 100-110° C., must be lower (less viscous) then the viscosity of the coal tar decanter sludge alone over the range temperature of 100-110° C.

Another important aspect of the fuel compositions and methods described herein is that the Steel Industry Fuel does not significantly reduce the heat content of the coking waste product. That is, the energy available from the combustion of the Steel Industry Fuel per gram is at least 10 KJ/g, more preferably of at least 12 KJ/g, and preferably at least 15 KJ/g.

Another aspect of the fuel compositions and methods described herein is the process for making Steel Industry Fuel. Preferably the Steel Industry Fuel is a combination of the coking waste product, defined above, and the green solvent, preferably a biodiesel fuel or waste biodiesel fuel, both absorbed and/or adsorbed on coal. Preferably, prior to the addition of the liquid portion of the Steel Industry Fuel to the coal portion of the Steel Industry Fuel, for conveyance to the coking oven, the coking waste product should be processed to, in part, remove any non-combustible debris. Non-combustible debris is often metal or ceramic parts from the coking process and can be screened or filtered from the Steel Industry Fuel prior to pumping the Steel Industry Fuel into the coking oven.

One preferred embodiment for making the Steel Industry Fuel includes depositing the coking waste material on a screen in a container. The coking waste material is then contacted with the green solvent. For example the green solvent can be sprayed, poured, or flowed over the coking waste material. Preferably the green solvent is pumped to a position above the coking waste product and is the solvent permitted to wash over the coking waste product. Positioning the coking waste material on a screen above the container (collection tank) permits dissolved material and/or particles to flow through the screen and into a collection tank. Often the particles that flow through the screen are agglomerated particles of coal, coke, and/or coal tar. The mixture that falls or flows through the screen is generally refereed to herein as a heterogeneous mixture because of the multi-component composition and its non-homogeneous state prior to being thoroughly mixed for contact with coal to form the Steel Industry Fuel.

This heterogeneous mixture is preferably processed to reduce the size of the agglomerated particles, to more completely dissolve the coal tar and to homogenize the mixture. Processes for reducing the size of the agglomerated particles include impacting, grinding, and/or milling the agglomerated particles, and/or mixing and/or heating the heterogeneous mixture. As an agglomerated particle is processed, it reduces in size to a smaller particle and any soluble material holding insoluble portions of the agglomerated particle together are understood to dissolve, at least partially, in the green solvent. The process for reducing the size of the agglomerated particles may be slow and require multiple recirculation passes to reduce the size of the agglomerated particles sufficiently. The thus processed mixture may or may not be saturated with coking waste product and can be added to the coking waste product in the container by the methods applicable for the addition of the green solvent to the coking waste product. The repeated processing and recirculation of the agglomerated particles, application to the coking waste product and heating of the processed mixture produces a mixture that, in relation to the heterogeneous mixture, is a homogeneous mixture. As used herein, the homogeneous mixture is a mixture of the (1) green solvent, and (2) the soluble portions of the coking waste product, e.g., tar decanter sludge, and fine particles from the decanter sludge that were not soluble in the green solvent. Preferably, the fine particles are sufficiently small that they do not rapidly settle from a homogeneous solution that is kept in motion, more preferably the fine particles are sufficiently small that they do not impair the flow of the homogeneous mixture through pumps or conduits. Still more preferably, the fine particles are sufficiently small that they are easily suspended in a homogeneous solution stored in a storage tank that may or may not be emulsified with a sufficient quantity of emulsifying agent. The homogeneous mixture is applied to coal and is adsorbed and/or adsorbed by the coal to form Steel Industry Fuel.

Another important aspect of the compositions and methods described herein is the addition of the Steel Industry Fuel to the coking oven. Preferably, the Steel Industry Fuel is formed by the addition of the coking waste product and the green solvent to coal, prior to being conveyed to the coking oven, in a range of about 0.1 to about 0.8 gallons per ton of coal. More preferably, the Steel Industry Fuel is formed by the addition of the coking waste product and green solvent to coal in a range of about 0.25 to about 0.5 gallons per ton of coal.

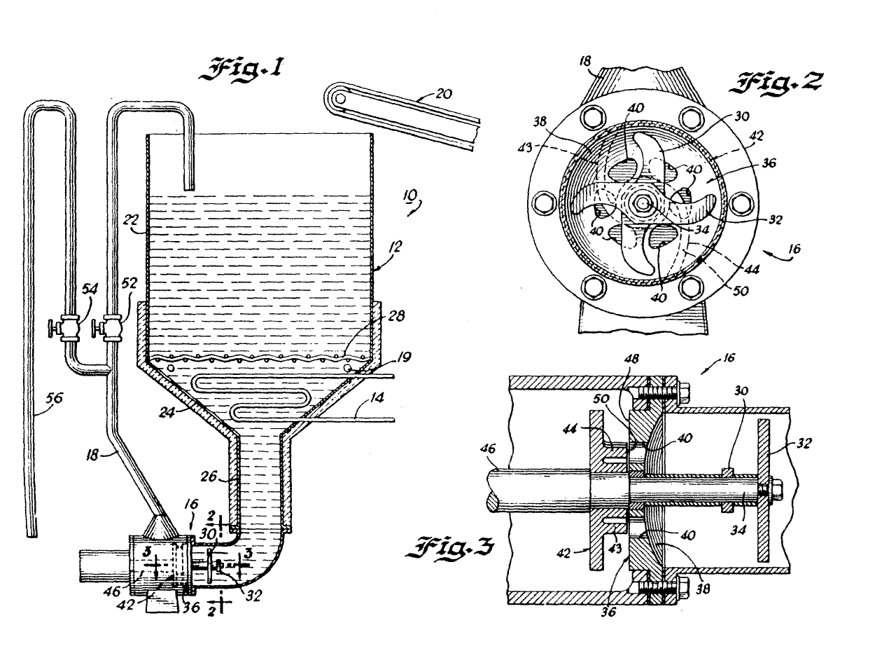

A detailed example of making the Steel Industry Fuel can be understood from the drawings. Turning now to the drawings and, initially to FIG. 1, there is an illustrated apparatus applicable in the present invention, generally designated 10, for fluidizing solid agglomerates of coal tar sludge from a coking oven to produce a solvent-diluted pumpable dispersion of coal and/or coke solid particles dispersed in a liquid. The apparatus 10 includes a mixing vessel, generally designated 12, a heating coil 14, a solids-liquid pump, generally designated 16 and a recirculation conduit 18 for recirculating the diluted solids-liquid dispersion back to the mixing vessel 12, when necessary. An annular air sparger 19 is disposed within the mixing vessel 19 to provide agitation to the liquid and dispersed solids to maintain good liquid-solid contact and provide a relatively homogeneous mixture. It is understood that any form of agitation, such as a mechanical agitation, could be used instead of the air sparger 19. The sparger 19 is generally an annular hollow tube operatively connected to a source of compressed air and includes a plurality of upwardly directed fluid openings (not shown). A suitable conveyor apparatus, generally designated 20, is disposed above the mixing vessel 12 to convey coal tar sludge, particularly a sludge including coal tar decanter sludge received directly from the coking oven, from a tar decanter vessel (not shown) into the mixing vessel 12. It is understood that any means for conveying the coal tar sludge into the mixing vessel 12 can be used in place of the conveyor 20. For example, a skip car mounted on an assembly (not shown) forming a vertical or inclined elevator ramp can be used for dumping the coal tar sludge into the top of the mixing vessel 12.

The mixing vessel 12 includes a generally annular upper portion 22 integral with a generally cone shaped lower portion 24 converging to a sludge mixing tank outlet conduit 26 in fluid communication with the solid-liquid pump 16.

A grate or liquid-porous screen 28 having flow-through passages of a predetermined size (e.g. ½ inch to one inch) is disposed within the annular portion 22 of the mixing vessel 12 for initially receiving and retaining the coal tar decanter sludge conveyed into the mixing vessel 12 from conveyor 20. The grate or screen 28 extends completely across the cross section of the mixing vessel 12 to prevent any solid particles or agglomerates larger than the pore size of the screen or grate 28 from reaching the pump 16.

In accordance with the preferred method described herein, coal tar sludge is conveyed into the mixing vessel 12 from conveyor 20 at the same time that a green solvent is conveyed into the mixing vessel 12. The green solvent collects in the mixing vessel 12 in the lower portion 24 and in the mixing tank outlet conduit 26 and the green solvent is heated by the heater 14 to a suitable temperature, e.g. 50-120° C.

The green solvent is added to the coal tar sludge in an amount of about 2-50% by weight or about 5-60% by volume and preferably in an amount of about 10-15 percent by total weight of coal tar sludge and green solvent. After heating the green solvent to a temperature of about 50-120° C. while in contact with at least a portion of the coal tar sludge, the hot solvent is recirculated through the mixing tank outlet 26 conduit, pump 16 and conduit 18 to the mixing tank 12. The recirculated hot, green solvent contacts the coal tar sludge in the mixing tank 12 thereby dissolving a portion of the coal tar and other residues binding the coal and coke solids to permit a portion of the coal tar sludge solid agglomerates to fall through the openings in the grate or screen 28.

The solid agglomerates falling through the screen 28 travel through the lower, cone-shaped portion 24 of the mixing tank 12, through the mixing tank outlet conduit 26 and into the pump 16. The solid particles approaching the pump 16 are agglomerates of coal tar sludge, and, in the case of coal tar decanter sludge, generally include about 10-50% by weight solid particles of coal and coke in the form of fine solid particles bound together cementaciously by coal tar and other residues received directly from the coke oven in the tar decanter vessel (not shown). The agglomerates initially approach the pump 16 having a particle size approximating that of the pore size of the grate or screen 28.

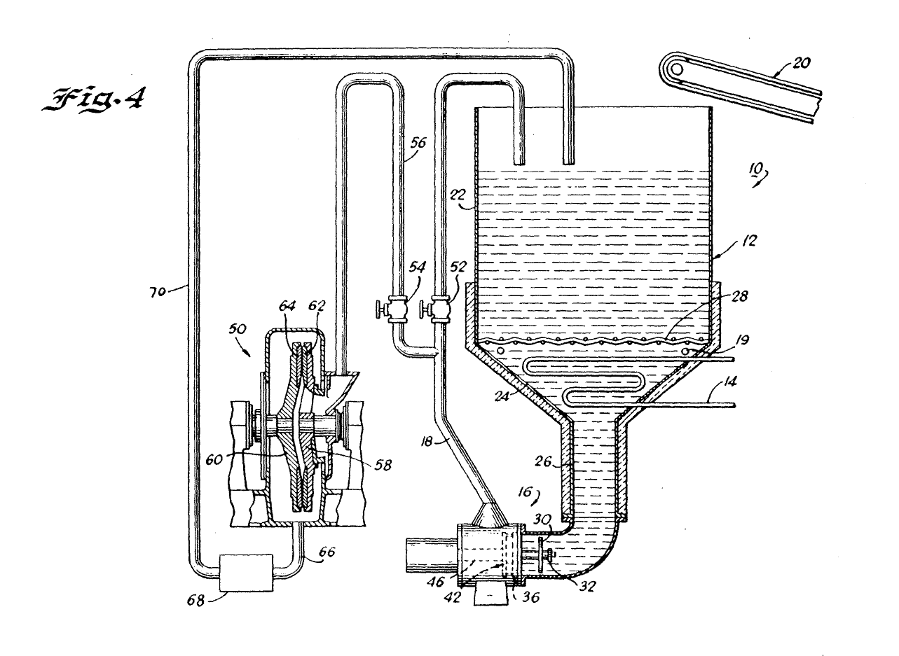

In accordance with a the preferred method described herein, the pump 16 (FIGS. 2 and 3) includes a pair of impact members or impact blades 30 and 32 rotatable about shaft 34 in a counterclockwise direction (as shown in FIG. 2) for impacting the solid agglomerates of coal and/or coke solid particles held together with the coal tar to reduce the particle size of the decanter sludge agglomerates. It is understood that the impact blades 30 and 32 need not form part of the pump 16 but can be rotated from a separate motor disposed before or after pump 16 in the recirculation loop formed by mixing tank outlet conduit 26, pump 16 and recirculation conduit 18. To achieve the full advantage of the preferred method described herein, the impact blades 30 and 32 are curved radially outwardly, when viewed from the shaft or central axis 34, in the direction of rotation of the blades 30 and 32, as best shown in FIG. 2.

In accordance with another feature of the preferred method described herein the pump 16 includes a shear plate, generally designated 36, having a concave inlet surface 38, to initially direct the sludge agglomerates from a planar rear surface of the impact blades 30 and 32 into an array of shear plate openings 40 in shear plate 36. In accordance with another important feature, the inner impact blade 30 is sufficiently spaced from the concave inlet surface 38 of the shear plate 36 and the inner and outer impact blades 30 and 32 are sufficiently spaced, e.g. at least 3 times the smallest pore or screen size dimension of the screen 28, to prevent agglomerates falling through screen 28 from binding between impact blades 30 and 32 or between the inner impact blade 30 and the concave shear plate inlet surface 38.

In accordance with another feature of the preferred method described, and shown in the drawings, an impeller generally designated 42, including two integral, spaced, curved impeller blades 43 and 44 rotatable about shaft 46, is disposed closely adjacent a back surface 48 of shear plate 36 (e.g., 0.005 inch spacing between back surface 48 of shear plate 36 and a front surface 50 of impeller blades 43 and 44). The impeller blades 43 and 44 include planar front and rear major surfaces and shear the solid agglomerates of coal and coke particles bound together with coal tar as the agglomerates exit the openings 40 in the back surface 48 of shear plate 36. The blades 43 and 44 shear the agglomerates and further reduce the agglomerate particle size to form a relatively homogeneous mixture of diluted coal and/or coke solid particles dispersed in diluted coal tar liquid. To achieve the full advantage of the present invention, the impeller blades 43 and 44 each include a planar surface adjacent the back surface 48 of the shear plate 36 and are curved radially outwardly, when viewed from the shaft or central axis 34, in a direction away from the direction of rotation of the impeller blades 43 and 44. It is understood that shearing need not occur within the pump 16, but a shear plate operatively associated with one or more impeller blades, as described, can be disposed at any other point after mechanical impacting. To achieve the full advantage of the present invention, the impact blades 30 and 32 contact the solid agglomerates prior to shearing.

The apparatus 10 provides recirculation of diluted coal tar and dispersed solids from the mixing tank 12 through the pump 16 and through the recirculating conduit 18 to reduce the particle size of the agglomerates conveyed to the mixing tank 12 until the mixture is sufficiently fluid and homogeneous. To achieve a dispersion suitable for use as a Steel Industry Fuel, the dispersed mixture should not have solid particles greater than about ⅛ inch in any dimension so that the dispersion is readily pumpable and sprayable.

In accordance with another embodiment of the preferred method described, and shown in FIG. 4, an attrition mill, generally designated by reference numeral 50 is provided for final particle size reduction of the diluted coal tar mixture. After sufficient treatment of the agglomerates in accordance with the apparatus 10, recirculation conduit valve 52 can be closed and valve 54 opened to feed the relatively homogeneous, diluted mixture through attrition mill feed conduit 56 between attrition mill annular steel plates 58 and 60 having closely spaced annular discs 62 and 64 attached at the radial ends. The attrition mill 50 is capable of further reducing the solids particle size of the diluted mixture after sufficient impacting and shearing as described above. Generally, the particle size of the agglomerates should be reduced, by impact blades 30 and 32 and shearing by impeller 42, to achieve a dispersion having at least 10% by weight of the solid particles less than ⅛″ in any dimension prior to treatment by attrition mill 50. The diluted coal tar-solids mixture exits the attrition mill 50 at outlet conduit 66 and is pumped by pump 68 through conduit 70 for recirculation to the mixing vessel 12 until a desired maximum solids particle size, e.g., 1/32 inch, is achieved in the homogeneous solution. The attrition mill 50 is only used when finer solids are necessary for example, for spraying the dispersion through fine spray nozzles. The homogeneous mixture then is applied to coal (not shown) to form Steel Industry Fuel.

The method and apparatus described herein is particularly suitable for fluidizing the many hazardous waste lagoons containing coal tar decanter sludge as well as other wastes, particularly mixtures of tar decanter sludge and other coal tar sludges such as tank sludge. Such waste mixtures sometimes contain only 2-5% coal and/or coke solids at intermediate levels of the lagoon and generally contain 5-40% coal and/or coke and other waste solids near the bottom of the lagoon. The dispersed solids in diluted liquid coal tar, when added to one or more green solvents, and absorbed and/or adsorbed onto coal, is an excellent fuel wherever fuels are used such as in cement kilns, lime plants, large utility plants, and particularly in a steel mill where fuels having a high carbon percentage are valuable such as in a blast furnace, open hearth furnace, steel mill boilers, and soaking pits.

In accordance with another important embodiment, the green solvent-diluted and heated coal tar-solids mixture can be diverted from the depicted apparatus, pumped through a conduit (not shown), and added to the coal to form Steel Industry Fuel on a conveyer belt or coal chute on route to coking oven. The diverted, diluted coal tar-solids are metered onto coal at a rate of about 0.1 to about 0.8 gallons, preferably about 0.25 to about 0.5 gallons of the material per ton of the coal delivered the coking oven.

In accordance with another important embodiment, continuous mixing of the coal tar sludge with a hot green solvent at a temperature of at least about 50° C. within the mixing vessel 12, such as by using a mechanical mixer or spayer within the mixing vessel 12, can eliminate the need for the grate or screen 28. The agglomerates within mixing vessel 12, when sufficiently mixed and in contact with hot green solvent, will cause solubilization of a sufficient amount of tar to achieve sufficiently small solid particles to be handled by the impacting blades 30 and 32 and the shear plate 38 and shearing blades 43 and 44. It is understood that the green solvent can be heated prior to delivery within the mixing vessel 12 and the mixing vessel sufficiently insulated to eliminate the need for continuous heating within the mixing vessel 12 by heating coil 14.

While there has been described what is at present considered to be the preferred embodiment of the invention, it will be understood that various modifications may be made therein which are within the true spirit and scope of the invention.

What is claimed:

1. A method of reducing fuel and disposal costs comprising:
processing coal tar sludge with about 1 to about 40 wt. % of a liquid fuel to make a liquefied sludge; wherein a liquid fuel cost per ton is less than a coal tar sludge waste disposal cost per ton;
applying the liquefied sludge to coal to make a Steel Industry Fuel;
calculating a barrel-of-oil equivalency credit; wherein the barrel-of-oil equivalency credit is a per rata credit based on British thermal units (BTUs) per ton available from the Steel Industry Fuel, wherein the available BTUs per ton are dependent on the Steel Industry Fuel composition comprising the liquid fuel, the coal tar sludge, and the coal; and
adjusting the composition of the Steel Industry Fuel to reduce the cost of liquid fuel and increase the BTUs per ton obtained from the Steel Industry Fuel upon combustion.

2. The method of claim 1 further comprising adding the Steel Industry Fuel to a coking oven.

3. The method of claim 1, wherein the liquid fuel is selected from the group consisting of No. 1 fuel oil, No. 2 fuel oil, No. 3 fuel oil, No. 4 fuel oil, No. 5 fuel oil, No. 6 fuel oil, biodiesel, biodisel waste product, glycerin, waste oil, and a mixture thereof.

4. The method of claim 2 further comprising offsetting a decrease in the available BTUs per ton against a contracted for price for the liquid fuel.

5. The method of claim 1, wherein processing coal tar sludge comprises:
heating the liquid fuel to a temperature in a range of 50 to 120° C.;
adding the liquid fuel to a coal tar sludge, wherein the coal tar sludge is supported on a screen above a container, and wherein a portion of the liquid fuel dissolves a portion of the coal tar sludge such that a heterogeneous mixture of the liquid fuel, the coal tar sludge, and agglomerated particles passes through the screen into the container;
reducing the agglomerated particles to smaller particles;
pumping a portion of the heterogeneous mixture to contact the coal tar sludge supported on the screen; and
recirculating a portion of the heterogeneous mixture for contact with a remaining portion of the coal tar sludge supported on the screen, until the coal tar sludge and liquid fuel form a recirculated heterogeneous mixture, wherein the recirculated heterogeneous mixture comprises the liquid fuel, and the coal tar sludge, including particles of coal and coke.

6. The method of claim 5, wherein the liquid fuel is selected from the group consisting of biodiesel, a biodiesel waste product, and a mixture thereof.

7. The method of claim 1, wherein the Steel Industry Fuel is sold to a coking operator.

8. A method comprising:
adjusting a composition of a Steel Industry Fuel comprising a liquid fuel capable of fluidizing a portion of a coal tar sludge at elevated temperature, the coal tar sludge, and a coal, to increase the BTUs per ton obtained from the Steel Industry Fuel upon combustion;
adjusting a composition of the Steel Industry Fuel to minimize a liquid fuel cost per ton.

9. A method of making a Steel Industry Fuel comprising:
solublizing a portion of a coking waste product with a non petroleum-based solvent to form a coking waste product solvent mixture at a temperature in a range of about 50° C. to about 120° C., wherein a mixture of the non-petroleum-based solvent and a liquid portion of the coking waste product has a lower viscosity than the coking waste product prior to the addition of the non-petroleum-based solvent and wherein the solvent is a combustible fuel derived from a vegetable oil or animal fat source; and
adding the coking waste product/solvent mixture to coal.

10. The method of claim 9, wherein the non-petroleum-based solvent is a biodiesel product.

11. The method of claim 10, wherein the non-petroleum-based solvent is a waste biodiesel product.

12. The method of claim 9, further including the step of adding about 0.1 gallons to about 0.8 gallons of the mixture to about one ton of coal in a coking oven to form Steel Industry Fuel.

13. A method of making coke for the steel industry comprising:
heating a biodiesel product to a temperature in a range of 50 to 120° C.,
adding the biodiesel product to a coking waste product, wherein the coking waste product is supported on a screen above a container, and wherein a portion of the biodiesel product liquefies a portion of the coking waste product such that a heterogeneous mixture of the biodiesel product, the liquefied coking waste product, and agglomerated particles of the coking waste product passes through the screen into the container,
reducing the agglomerated particles to smaller particles, by contact with the biodiesel product,
pumping a portion of the biodiesel product and liquefied coking waste product back to contact the coking waste product supported on the screen,
recirculating a portion of the biodiesel product and liquefied coking waste product for contact with a remaining portion of the coking waste product, supported on the screen, until the coking waste product and biodiesel product form a homogeneous mixture, wherein the homogeneous mixture comprises the biodiesel product, and the coking waste product, including particles of coal and coke,
mixing a about 0.1 to about 0.8 gallons of the homogeneous mixture with about one ton of coal to form Steel Industry Fuel, and
adding the Steel Industry Fuel to a coking oven during the manufacture of coke.

14. A fuel mixture capable of being heated sufficiently to manufacture coke, useful to make steel, comprising:
a non-petroleum-based solvent,
a coking waste product, and
coal;
wherein the non-petroleum-based solvent is derived from an animal fat and/or vegetable oil source, and wherein about 0.25 to about 0.5 gallons of a mixture of the non-petroleum-based solvent and the coking waste product is admixed with about one ton of coal for delivery to a coking oven to manufacture coke.

15. The fuel mixture of claim 14, wherein the non-petroleum-based solvent is a biodiesel product.

16. The composition of claim 14, wherein a mixture of the non-petroleum-based solvent and the coking waste product has a heat content of at least 10,000 J/g.

17. A method of making coke using a Steel Industry Fuel comprising:
admixing a coal tar sludge and a biodiesel product solvent to produce a mixture that comprises about 1 to about 99 wt % coal tar sludge and about 1 to about 99 wt. % solvent;
heating the mixture of the coal tar sludge and biodiesel product to decrease the viscosity of the mixture; and
pumping the heated mixture of the coal tar sludge and biodiesel product onto coal to form Steel Industry Fuel for delivery to a coking oven that is held at a temperature and under anaerobic conditions sufficient to form coke from said Steel Industry Fuel.

18. The method of claim 17, wherein the biodiesel product comprises a waste biodiesel product.

19. The method of claim 17, wherein the mixture of the coal tar sludge and the non-petroleum-derived solvent comprises solid, agglomerated particles of coal and coke, and further including the step of impacting the solid particles to physically break agglomerates thereof.

20. The method of claim 17, wherein the mixture of the coal tar sludge and the biodiesel product comprises about 20 to about 80 wt. % of the coal tar sludge and about 20 to about 80 wt. % solvent.

21. The method of claim 20, wherein the mixture of the coal tar sludge and the biodiesel product comprises about 25 to about 50 wt. % of the coal tar sludge and about 50 to 75 wt. % solvent.
